(19) United States
(12) Patent Application Publication
(10) Pub. No.: US 2007/0050643 A1
(43) Pub. Date: Mar. 1, 2007

(54) Information processing apparatus, information processing method, and program storage medium

(75) Inventor: Yasuyuki Negishi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/268,644

(22) Filed: Nov. 8, 2005

(30) Foreign Application Priority Data
Aug. 30, 2005 (JP) 2005-249197

(51) Int. Cl. H04N 7/16; G06Q 99/00; G06F 12/14; H04L 9/32; G06F 17/30; H04L 9/00; G06F 11/30; G06F 7/04; H04K 1/00; G06K 9/00; H03M 1/68

(52) U.S. Cl. 713/193; 726/26; 705/59

(57) ABSTRACT

The present invention relates to an information processing apparatus typified by a personal computer and the like and employs a versatile technique capable of preventing unauthorized use of software effectively. An information processing apparatus has a storage section which stores software at least part of which is encrypted; a media mounting section on which a storage medium containing a key for use to decrypt the software stored in the storage section is removably mounted; a decryption section which decrypts the software stored in the storage section using the key contained in the storage medium mounted on the media mounting section; and a computing section which executes the software decrypted by the decryption section.

### BACKGROUND OF THE INVENTION

1. Field of the Invention

The present invention relates to an information processing apparatus such as a personal computer and the like, an information processing method executed in the information processing apparatus, and program storage medium.

2. Description of the Related Art

Recently, personal computers (hereinafter abbreviated to PC) have spread widely not only among offices, but also among homes.

One of serious problems under these circumstances is how to prevent unauthorized use of software.

For example, Japanese Patent Laid-Open No. 6-223040 proposes a technique which involves installing a software license management system on a network, setting a limit to the number of available copies of software under management, and permitting simultaneous execution of the software only within the limit.

Also, Japanese Patent Laid-Open No. 2002-100116 proposes a technique which involves storing user identification information during recording of recording data and permitting reproduction of the recording data only if the user identification information recorded together with the recording data matches user identification information recorded separately.

Furthermore, International Publication WO 98/27494 proposes a technique which allows an electronic document to be displayed on browser software only if a permission to display the electronic document, or a decryption key if the electronic document is encrypted, is received via a network.

A large number of techniques for preventing unauthorized use of software have been proposed in addition to the techniques described above. Although they are effective in respective special environments, they actually employ a system in which, for example, software stored in a purchased CD and uploaded from the CD to a PC becomes available for use once a license number attached to the CD is keyed in. Therefore, as long as the CD is stored together with the license number, it can be copied freely, allowing the software to be run on any number of PCs simultaneously.

### SUMMARY OF THE INVENTION

The present invention has been made in view of the above circumstances and provides an information processing apparatus, information processing method, and program storage medium which employ a versatile technique capable of preventing unauthorized use of software effectively.

The present invention provides an information processing apparatus having:

a storage section which stores software at least part of which is encrypted;

a media mounting section on which a storage medium containing a key for use to decrypt the software stored in the storage section is removably mounted;

a decryption section which decrypts the software stored in the storage section using the key contained in the storage medium mounted on the media mounting section; and

a computing section which runs the software decrypted by the decryption section.

Since the information processing apparatus according to the present invention stores software with at least part of it encrypted and allows it to run only after it is decrypted with the key contained in the storage medium mounted on the media mounting section, the software is allowed to run only when the storage medium containing the key is mounted. Thus, even if the software is copied to a number of PCs and the like, it can run at a time only on a single PC or the like onto which the storage medium is loaded. This prevents unauthorized use of software effectively.

In the information processing apparatus according to the present invention, preferably the media mounting section is loaded with a storage medium containing the key as well as license terms for execution of the software; and

the decryption section decrypts the software stored in the storage section using the key contained in the storage medium mounted on the media mounting section, providing that the license terms contained in the storage medium are satisfied.

In that case, preferably the media mounting section is loaded with a storage medium containing the key as well as containing a license period of the software as the license terms; and

the decryption section decrypts the software stored in the storage section using the key contained in the storage medium mounted on the media mounting section only within the license period contained in the storage medium. Alternatively, the information processing apparatus has a position detecting section which detects current position, wherein the media mounting section is loaded with a storage medium containing the key as well as containing, as the license terms, licensing area information which specifies areas where execution of the software is permitted; and

the decryption section decrypts the software stored in the storage section using the key contained in the storage medium only when the current position detected by the position detecting section is within the areas which are specified by the licensing area information contained in the storage medium mounted on the media mounting section and in which execution of the software is permitted.

Furthermore, in the information processing apparatus according to the present invention, preferably the media mounting section can be simultaneously loaded with a first storage medium containing the key and a second storage medium containing user information which indicates an authorized user of the software; and

the decryption section decrypts the software stored in the storage section using the key contained in one of the two storage media mounted on the media mounting section, providing that the user information which indicates an authorized user of the software is contained in the other one of the two storage media.

The arrangement which allows the software to run only when both the storage medium containing the key and storage medium containing the user information are in place is effective not only in preventing unauthorized use of the software, but also in user's information management because the user can restrain others from using the software.

Incidentally, although the information processing apparatus of the present invention has been described above, the technical ideas of the present invention may be implemented as an information processing method or program storage medium.

Thus, the present invention makes it possible to implement a versatile technique capable of preventing unauthorized use of software effectively.

### BRIEF DESCRIPTION OF THE DRAWINGS

FIG. 1 is an external perspective view of a personal computer (PC) as an embodiment of the present invention;

FIG. 2 is a diagram showing a software license management environment surrounding the PC;

FIG. 3 is a diagram showing an internal configuration and surrounding environment of the PC according to this embodiment;

FIG. 4 is an explanatory diagram illustrating how an OS is loaded when it is executed;

FIG. 5 is an explanatory diagram illustrating a case in which a PC running an OS placed under license management is broken and the OS is going to be executed on another PC;

FIG. 6 is a flowchart of OS installation procedures according to this embodiment;

FIG. 7 is a flowchart of OS start-up procedures according to this embodiment;

FIG. 8 is a flowchart of a user registration process represented by a single step in FIG. 7;

FIG. 9 is a flowchart of an OS start-up process represented by a single step in FIG. 7;

FIG. 10 is a diagram showing an internal configuration of a PC according to a second embodiment;

FIG. 11 is an explanatory diagram illustrating how the OS is loaded when it is executed on the PC 10 shown in FIG. 10;

FIG. 12 is a flowchart of an OS start-up process according to the second embodiment; and

FIG. 13 is a diagram showing an internal configuration of a PC according to a third embodiment.

### DETAILED DESCRIPTION OF THE INVENTION

Embodiments of the present invention will be described below.

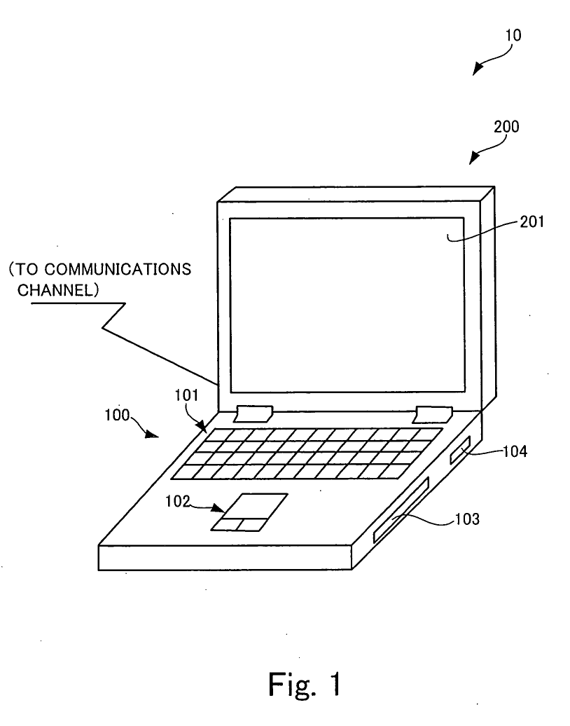

FIG. 1 is an external perspective view of a personal computer (PC) as an embodiment of the present invention.

The PC 10 consists of a main body 100 and a display section 200 attached to it openably/closably. The display section 200 has an image display 201 which almost occupies the entire front face. The main body 100 incorporates a CPU (central processing unit), a memory, a hard disk, communications ports, etc. On the top face of the main body 100, there are a keyboard 101 used by the user to enter commands in the PC 10 as well as a track pad 102 which is a kind of pointing device used by the user to specify a desired location on the display 201 and thereby give a command corresponding to an icon or the like displayed at the specified location. As shown in FIG. 1, on side faces of the main body 100, there are a loading slot 103 of a CD/DVD drive which accesses a CD or DVD (hereinafter collectively referred to as a CD/DVD) loaded on it as well as a media loading slot 104 of media controller which accesses a portable storage medium such as an IC card loaded on it.

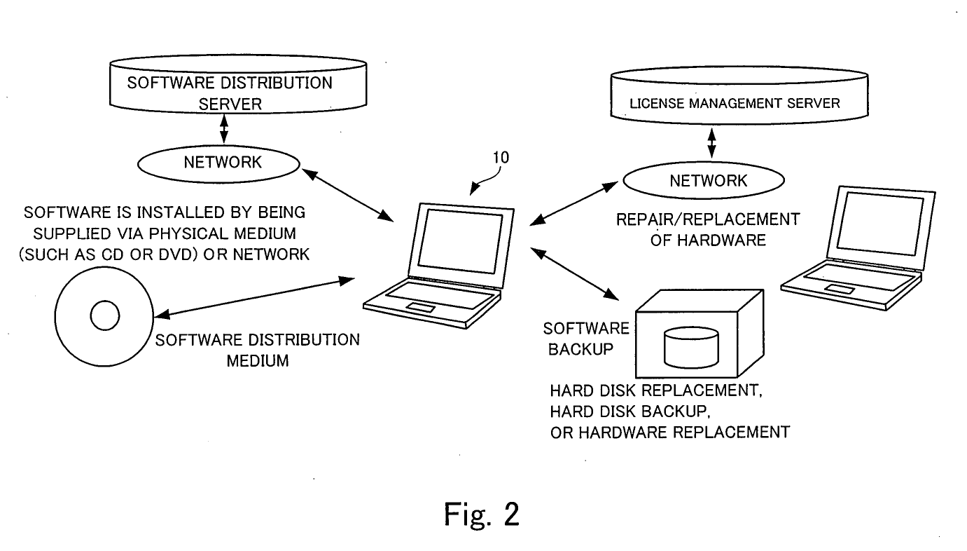

FIG. 2 is a diagram showing a software license management environment surrounding the PC 10. Although description will be given here taking an OS (operating system) as an example of the software under management, the description similarly applies to cases in which the software under management is an application program.

The software under management (the OS, in this case) has at least part of itself encrypted. The program (OS) is supplied to the PC 10 by means of a physical medium (such as CD or DVD) for software distribution, or by a server for software distribution via a network.

Once the software under management is installed on the PC 10, it is registered under the name of its user with a license management server via a network.

Also, as described later, the software installed on the PC 10 can be run only after a storage medium containing cryptographic key data is loaded, and thus the software and any data resulting from execution of the software can be backed up onto a hard disk (HDD) separate from the PC 10 or onto another PC. Even if the software is backed up onto another PC, it cannot be run on the PC unless the storage medium is loaded onto the PC. This prevents unauthorized use of the software.

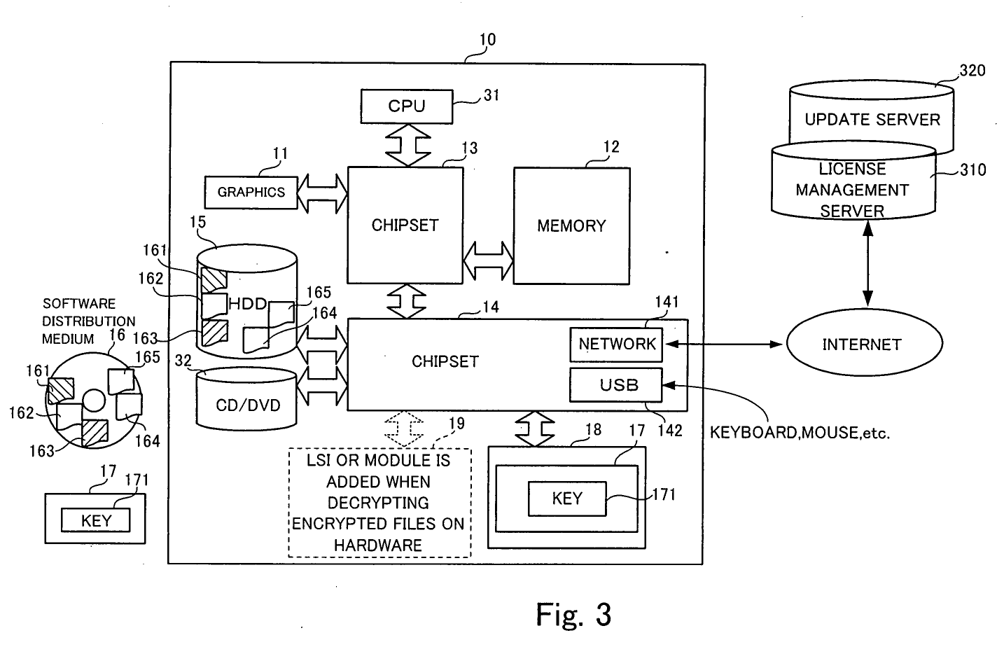

FIG. 3 is a diagram showing an internal configuration and surrounding environment of the PC according to this embodiment.

The PC 10 has a CPU 31; graphics circuit 11 for image display; memory 12; chipset 13 for memory control; chipset 14 for I/O control of a network 141, USB 142, and the like; hard disk 15, CD/DVD drive 32 on which a CD/DVD 16 is removably loaded; and a media drive 18 on which a storage medium 17 is removably mounted. Also, a decryption module 19 is indicated by broken lines. It is needed when performing decryption on the hardware, but is not needed when performing decryption on the software.

It is assumed here that the user has purchased a software distribution CD or DVD (hereinafter referred to as a CD/DVD 16). The CD/DVD 16 contains an OS (operating system) being a kind of software to be managed here. The OS consists of various files 161, 162, 163, and so on, one of which is a file 161 containing a license agreement. A license agreement number unique to the OS stored in the-CD/DVD 16 has been steganographically embedded in the license agreement although it is imperceptible to the user who displays and reads the license agreement. Also, another one of the various files 161, 162, 163, and so on composing the OS stored in the CD/DVD 16 is an encrypted file 163. The file 163 is basic software of the OS and it is essential for proper operation of the entire OS that the file 163 is executed.

When the CD/DVD 16 is purchased, a storage medium 17 containing cryptographic key data 171 is packaged with it. The cryptographic key data 171 contained in the storage medium 17 constitutes a decryption key used to decrypt the encrypted file 163 in the OS. Possible encryption techniques used in this embodiment include, for example, Rijndael which is a common key encryption algorithm selected by NIST (National Institute Standards and Technology) in AES (Advanced Encryption Standard).

As the CD/DVD 16 is loaded on the PC 10, the OS stored on it is uploaded onto the PC 10 and stored on the hard disk 15. On the other hand, the storage medium 17 containing the cryptographic key data 171 is loaded on the media drive 18 of the PC 10.

The PC 10 is connected to a license management server 310 and update server 320 via the Internet. When the user starts up the OS stored on the hard disk 15 for the first time, the license agreement number embedded in the license agreement file 161 as well as user information entered by the user at the first start-up are sent to and registered with the license management server 310. The update server 320 sends update information about the OS to the PC of each user registered with the license management server 310, and consequently the OS is updated on the user's PC.

In order for the PC 10 to run the OS stored on the hard disk 15, the OS is read out of the hard disk 15, the non-encrypted files of the OS are loaded into the memory 12 directly while the encrypted file 163 is loaded into the memory 12 after being decrypted with the cryptographic key data 171 read out of the storage medium 17 by the media drive 18, and the files are executed by the CPU 31.

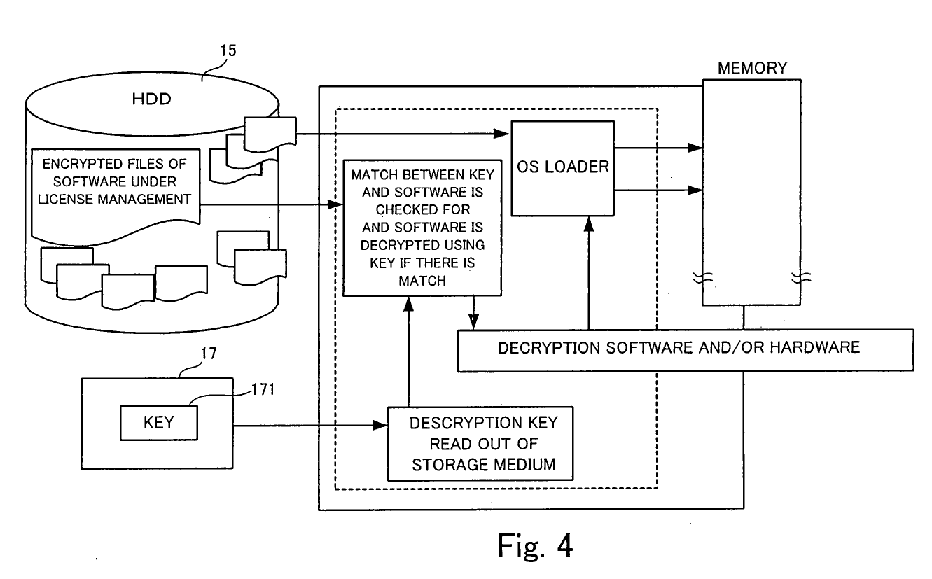

FIG. 4 is an explanatory diagram illustrating the process of loading the OS when the OS is executed.

Among the various files of the OS stored on the hard disk 15, the files for the processes enclosed by broken lines in FIG. 4 are not encrypted. They are read out of the hard disk 15 first of all and stored in memory by an OS loader. When the encrypted file among the various files of the OS is read out of the hard disk 15, the cryptographic key data 171 for decryption is read out of the storage medium 17 as well and it is checked whether the decryption key matches the software. If a match is verified, the software is decrypted using the key. The decryption process is performed using decryption software and/or a hard disk. The file subjected to the decryption process is loaded into memory by the OS loader. Once all the files needed for execution of the OS are loaded into memory, the OS is ready to execute.

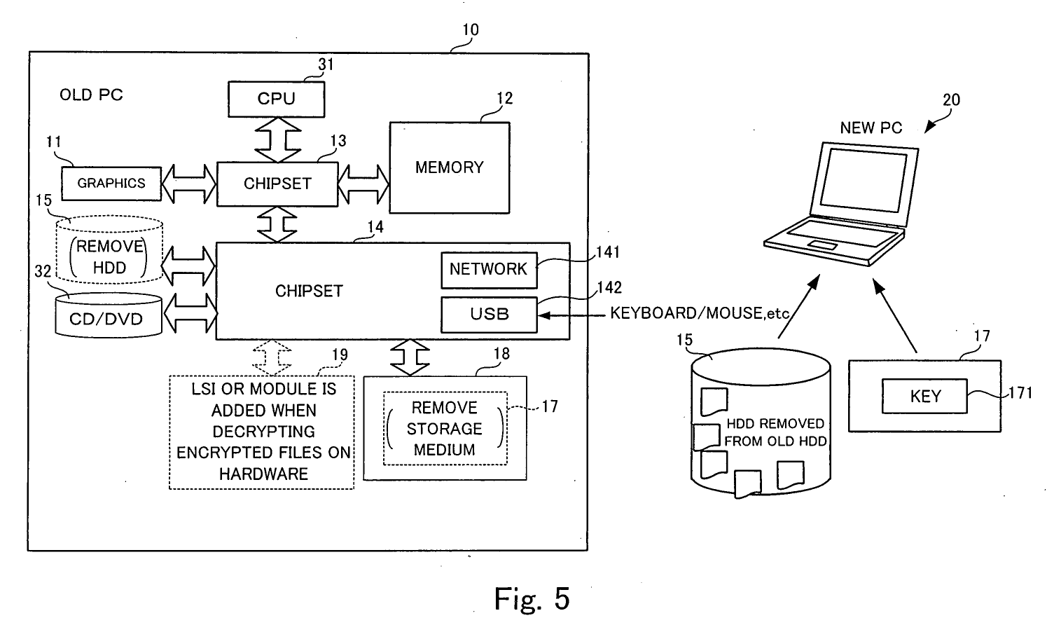

FIG. 5 is an explanatory diagram illustrating a case in which a PC 10 running an OS placed under license management is broken and the OS is going to be executed on another PC. The same components of the PC as those in FIG. 3 are denoted by the same reference characters as the corresponding components in FIG. 3 and only differences will be described.

The hard disk 15 is mounted on a new PC 20 after being removed from the old PC 10 on which it was used before. Also, the storage medium 17 containing the cryptographic key data 171 for decryption is removed from the old PC 10 and mounted on the new PC 20. Consequently, the new PC 20 is complete with the OS and storage medium 17 and is ready to run the OS.

Incidentally, although a case in which the hard disk 15 is removed from the old PC 10 and mounted on the new PC 20 has been described above, since the OS itself can be copied any number of times, only the storage medium 17 may be mounted on the new PC 20 by newly downloading the OS from the software distribution CD/DVD 16 (see FIG. 3) onto the new PC 20.

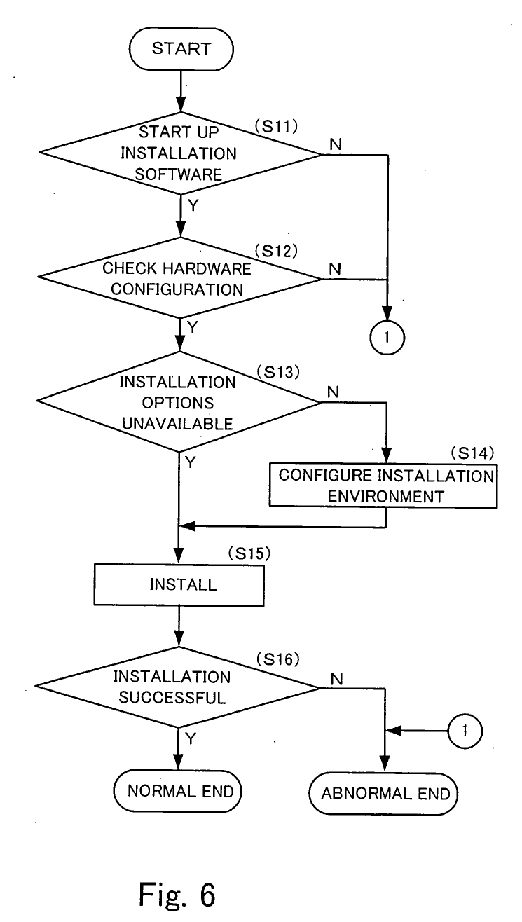

FIG. 6 is a flowchart of OS installation procedures according to this embodiment.

First, installation software starts up (step S11) and checks whether the PC hardware meets system requirements of the OS (step S12). If the installation software fails to start up or the PC hardware does not meet the system requirements of the OS, an abnormal end occurs.

After the PC hardware is checked, it is determined whether there are installation options. The installation options include, for example, selecting from multiple installation locations such as a hard disk or selecting functions to install. If installation options are available, the installation environment is configured (an installation location is selected, functions to be installed are selected, and so on) (step S14) before the OS is installed (step S15). If no installation option is available, the OS is installed immediately (step S15). Then, it is determined whether there was nothing wrong during the installation (step S16).

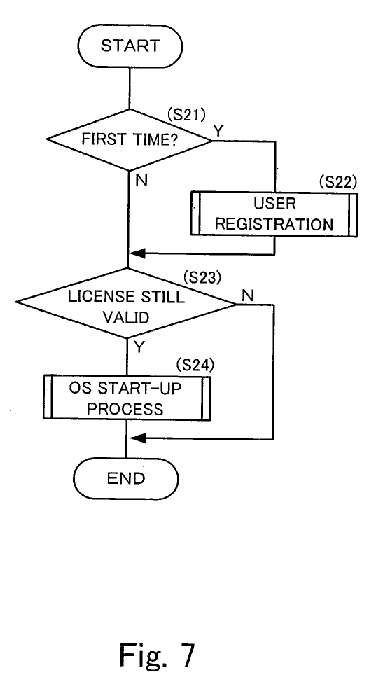

FIG. 7 is a flowchart of OS start-up procedures according to this embodiment.

When the OS is started, for example, by turning on the PC, it is determined first whether this is the first start-up of the OS (step S21). If this is the first start-up, user registration is performed (step S22). Next, it is determined whether the license is still valid (step S23). If the license is still valid, the OS is started (step S24).

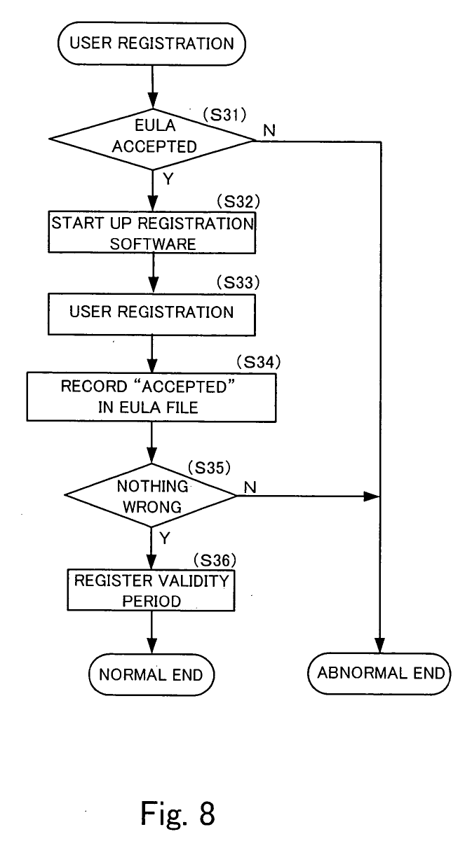

FIG. 8 is a flowchart of a user registration process represented by a single step in FIG. 7.

First, it is determined whether EULA (End User License Agreement) is accepted (step S31). The EULA appears on the display screen, asking the user whether the user accepts the terms of the agreement.

When the user accepts the EULA, registration software starts up (step S32) to perform user registration (step S33). In the user registration, the user enters his/her name and the like and the user name is sent to the license management server together with the license agreement number and the like steganographically embedded in the license agreement file.

Next, “Accepted” is recorded in the EULA file (step S34) and if the process so far is finished successfully (step S35), the validity period is registered in the recording medium 17.

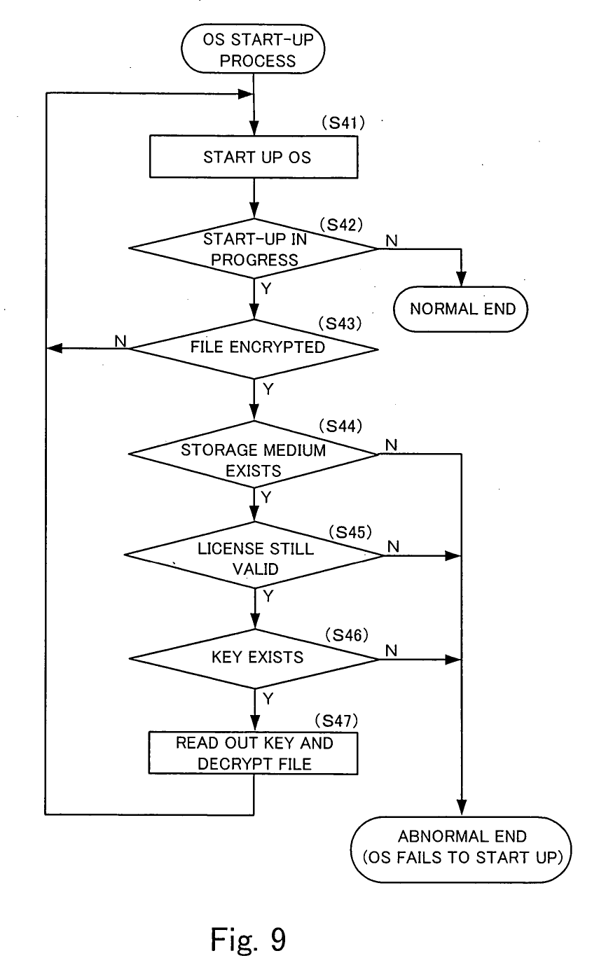

FIG. 9 is a flowchart of an OS start-up process represented by a single step in FIG. 7.

An OS start-up process which involves reading the OS out of the hard disk and loading it into memory is performed here (step S41) as described with reference to FIG. 4. In the start-up process (step S42), it is checked whether the file read out of the hard disk is encrypted. If the file is encrypted, it is checked whether a storage medium exists (step S44), whether the license is still valid (step S45), and whether a decryption key exists in the storage medium (step S46). Then, the key is read out and the file is decrypted (step S47). On the other hand, if the file is not encrypted (step S43), the OS start-up process is continued, skipping the decryption process (step S41).

According to this embodiment, since the decryption key is stored in the storage medium as described above, the software cannot (OS, in this case) run unless the storage medium is loaded. This prevents unauthorized use.

Next, a second embodiment of the present invention will be described.

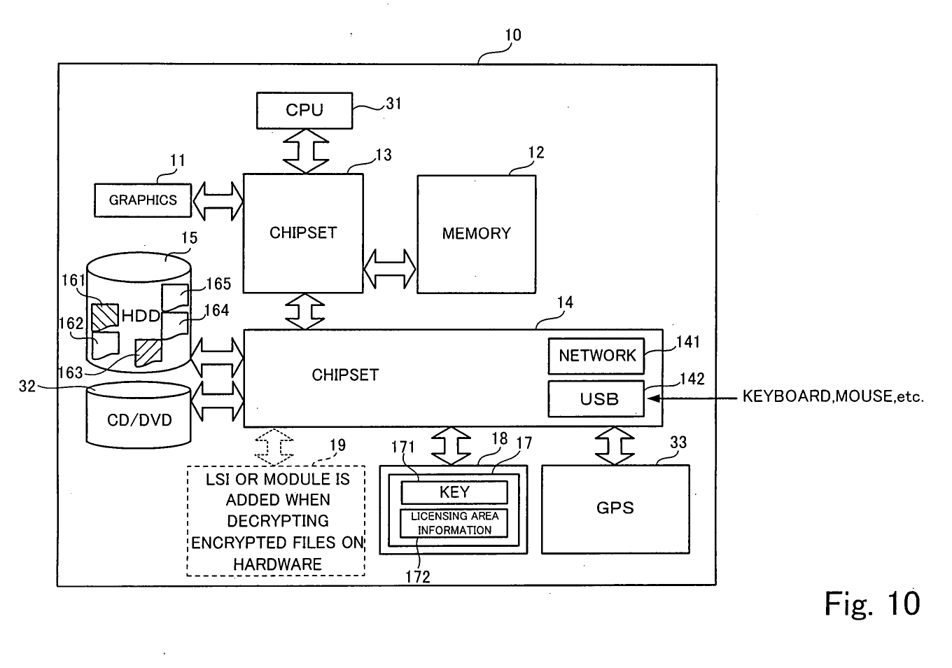

FIG. 10 is a diagram showing an internal configuration of a PC according to the second embodiment. Outward appearance of the PC according to the second embodiment is the same as the first embodiment described above (see FIG. 1), and thus illustration and description thereof will be omitted. Again, only differences from the embodiment described with reference to FIG. 3 will be described here in FIG. 10.

In the PC 10 shown in FIG. 10, the storage medium 17 contains licensing area information 172 in addition to the cryptographic key data 171 for decryption. The licensing area information 172 indicates geographic areas where the OS is allowed to be run (e.g., only within Japan).

Also, the PC 10 shown in FIG. 10 incorporates GPS (Global Positioning System) 33. The GPS 33 is a system which tells current geographic location by receiving radio waves from satellites.

Operation of the OS during installation on the PC 10 shown in FIG. 10 is the same as the first embodiment described above, and thus redundant description thereof will be omitted.

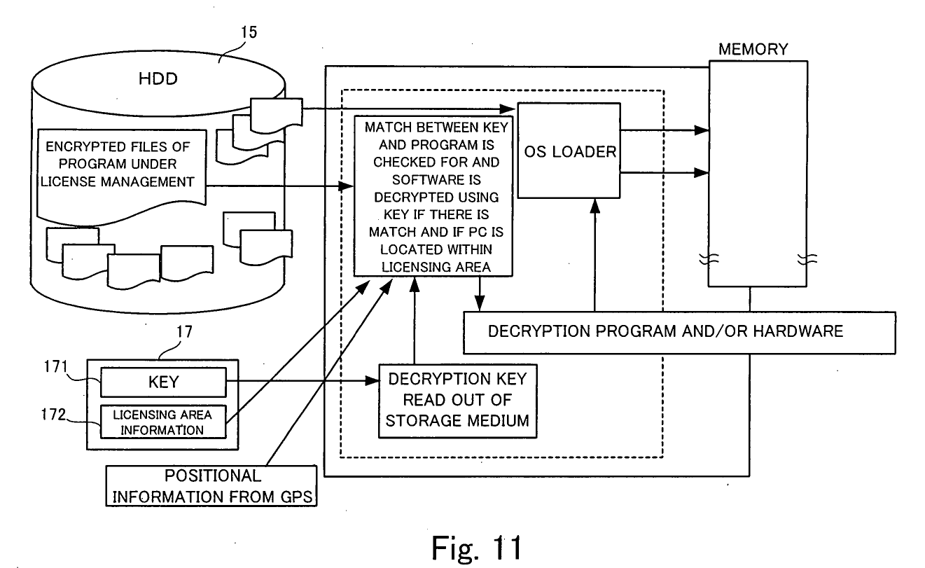

FIG. 11 is an explanatory diagram illustrating how the OS is loaded when it is executed on the PC 10 shown in FIG. 10. FIG. 11 corresponds to FIG. 4 in the first embodiment, and thus only differences from FIG. 4 will be described here.

FIG. 11 differs from FIG. 4 in procedures for decrypting an encrypted file: the licensing area information 172 in the storage medium 17 is checked against positional information from the GPS and only if the location of the PC as indicated by the positional information from the GPS falls within a licensing area, the encrypted file is decrypted using the cryptographic key data 171. In other respects, FIG. 11 is the same as FIG. 4, and thus redundant description thereof will be omitted.

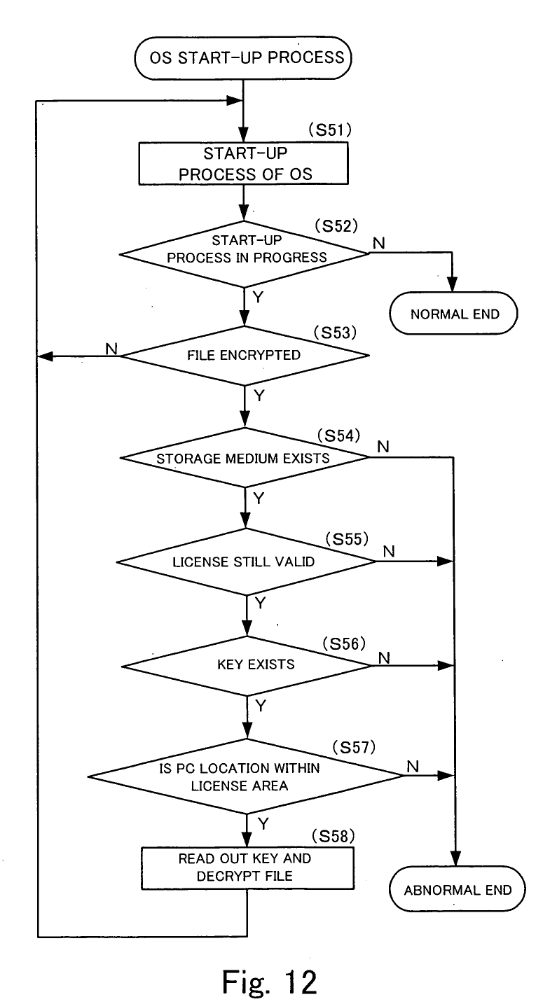

FIG. 12 is a flowchart of an OS start-up process according to the second embodiment. The flowchart in FIG. 12 corresponds to the flowchart according to the first embodiment in FIG. 9, and thus only differences from FIG. 9 will be described here.

Steps S51 to S56 and S58 in the flowchart of FIG. 12 are the same as steps S41 to S46 and S47 in FIG. 9, respectively, and thus redundant description thereof will be omitted.

The difference between the flowcharts in FIG. 12 and in FIG. 9 lies in step S57 where it is determined whether the location of the PC falls within a licensing area. Decryption is performed only if the location of the PC falls within a licensing area (step S58).

According to the second embodiment, the storage medium 17 contains the licensing area information 172 in addition to the decryption key, and thus if the storage medium 17 does not exist, the OS is not executed and is prevented from unauthorized use, as is the case with the first embodiment. Besides, the OS cannot be used outside the licensing areas.

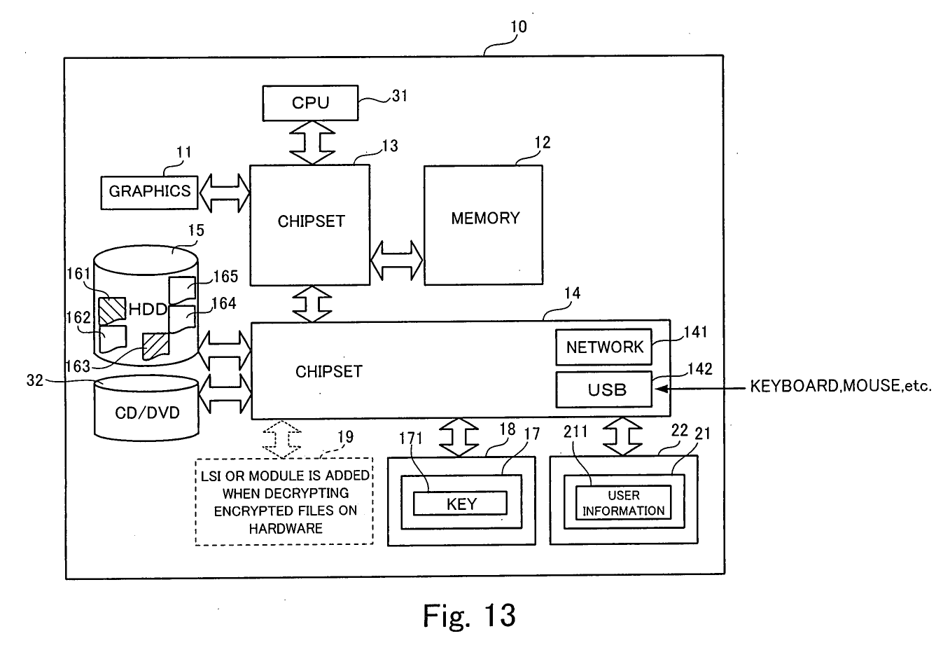

FIG. 13 is a diagram showing an internal configuration of a PC according to a third embodiment. Again, description of outward appearance will be omitted and only differences from the first embodiment in FIG. 3 will be described here.

The PC 10 shown in FIG. 13 is equipped with two media drives 18 and 22 on which two storage media 17 and 21 are removably mounted. The storage medium 17 containing the cryptographic key data 171 for decryption is mounted on one of the media drives 18. During user registration, user information is stored on the storage medium 21 mounted on the other media drive 22 (see FIGS. 7 and 8).

According to the third embodiment, the user is prompted for user information (e.g., user name, user ID, or the like) again during start-up of the OS, the entered user information is checked against user information stored in the storage medium 21, and then decryption is performed using the cryptographic key data 171 stored in the storage medium 17 only if the two kinds of user information match.

In this embodiment, as in the case of the other embodiments, a precondition for execution of the OS is that the storage medium 17 containing the cryptographic key data 171 for decryption is mounted. This prevents unauthorized use of the OS in excess of the number of licenses. Also, since the OS can be executed only when user information provided by the user match user information stored in the storage medium 21, by unplugging the storage medium 22, it is possible to prevent other users from running the OS on the PC, and thus prevent, for example, theft of personal information.

What is claimed is:

1. An information processing apparatus comprising:
a storage section which stores software at least part of which is encrypted;
a media mounting section on which a storage medium containing key data for use to decrypt the software stored in the storage section is removably mounted;
a decryption section which decrypts the software stored in the storage section using the key data contained in the storage medium mounted on the media mounting section; and
a computing section which executes the software decrypted by the decryption section.

2. The information processing apparatus according to claim 1, wherein:
the media mounting section is loaded with a storage medium containing the key data as well as license terms for execution of the software; and
the decryption section decrypts the software stored in the storage section using the key data contained in the storage medium mounted on the media mounting section, providing that the license terms contained in the storage medium are satisfied.

3. The information processing apparatus according to claim 2, wherein:
the media mounting section is loaded with a storage medium containing the key data as well as containing a license period of the software as the license terms; and
the decryption section decrypts the software stored in the storage section using the key data contained in the storage medium mounted on the media mounting section only within the license period contained in the storage medium.

4. The information processing apparatus according to claim 2, comprising a position detecting section which detects current position, wherein:
the media mounting section is loaded with a storage medium containing the key data as well as containing, as the license terms, licensing area information which specifies areas where execution of the software is permitted; and
the decryption section decrypts the software stored in the storage section using the key data contained in the storage medium only when the current position detected by the position detecting section is within the areas which are specified by the licensing area information contained in the storage medium mounted on the media mounting section and in which execution of the software is permitted.

5. The information processing apparatus according to claim 1, wherein:
the media mounting section can be simultaneously loaded with a first storage medium containing the key data and a second storage medium containing user information which indicates an authorized user of the software; and
the decryption section decrypts the software stored in the storage section using the key data contained in one of the two storage media mounted on the media mounting section, providing that the user information which indicates an authorized user of the software is contained in the other one of the two storage media.

6. An information processing method for an information processing apparatus equipped with a media mounting section on which a storage medium is removably mounted, comprising the steps of:
storing software at least part which is encrypted and mounting a storage medium containing key data for use to decrypt the software onto the media mounting section
decrypting the software using the key data contained in the storage medium mounted on the media mounting section; and
executing the software decrypted by the decryption section.

7. The information processing method according to claim 6, comprising the steps of:
loading a storage medium containing the key data as well as license terms for execution of the software onto the media mounting section; and
decrypting the software using the key data contained in the storage medium mounted on the media mounting section, providing that the license terms contained in the storage medium are satisfied.

8. The information processing method according to claim 7, comprising the steps of:
loading a storage medium containing the key data as well as containing a license period of the software as the license terms onto the media mounting section; and
decrypting the software using the key data contained in the storage medium mounted on the media mounting section only within the license period contained in the storage medium.

9. The information processing method according to claim 7, comprising the steps of:
loading a storage medium containing the key data as well as containing, as the license terms, licensing area information which specifies areas where execution of the software is permitted onto the media mounting section; and
detecting the current position and decrypting the software using the key data contained in the storage medium only when the detected current position is within the areas which are specified by the licensing area information contained in the storage medium and in which execution of the software is permitted.

10. The information processing method according to claim 6, comprising the steps of:
loading a first storage medium containing the key data and a second storage medium containing user information which indicates an authorized user of the software onto the media mounting section; and
decrypting the software using the key data contained in one of the two storage media mounted on the media mounting section, providing that the user information which indicates an authorized user of the software is contained in the other one of the two storage media.

11. A program storage medium storing a program executed on an information processing apparatus executing a program to make the information processing apparatus function as an information processing apparatus which comprises:
a storage section which stores software at least part of which is encrypted;
a media mounting section on which a storage medium containing key data for use to decrypt the software stored in the storage section is removably mounted;
a decryption section which decrypts the software stored in the storage section using the key data contained in the storage medium mounted on the media mounting section; and
a computing section which executes the software decrypted by the decryption section.

12. The program storage medium according to claim 11, wherein:
the media mounting section is loaded with a storage medium containing the key data as well as license terms for execution of the software; and
the decryption section decrypts the software stored in the storage section using the key data contained in the storage medium mounted on the media mounting section, providing that the license terms contained in the storage medium are satisfied.

13. The program storage medium according to claim 12, wherein:
the media mounting section is loaded with a storage medium containing the key data as well as containing a license period of the software as the license terms; and
the decryption section decrypts the software stored in the storage section using the key data contained in the storage medium mounted on the media mounting section only within the license period contained in the storage medium.

14. The program storage medium according to claim 12, wherein:
the information processing apparatus comprises a position detecting section which detects current position;
the media mounting section is loaded with a storage medium containing the key data as well as containing, as the license terms, licensing area information which specifies areas where execution of the software is permitted; and
the decryption section decrypts the software stored in the storage section using the key data contained in the storage medium only when the current position detected by the position detecting section is within the areas which are specified by the licensing area information contained in the storage medium mounted on the media mounting section and in which execution of the software is permitted.

15. The program storage medium according to claim 11, wherein:
the media mounting section can be simultaneously loaded with a first storage medium containing the key data and a second storage medium containing user information which indicates an authorized user of the software; and
the decryption section decrypts the software stored in the storage section using the key data contained in one of the two storage media mounted on the media mounting section, providing that the user-information which indicates an authorized user of the software is contained in the other one of the two storage media.
